(19) United States
(12) Patent Application Publication
(10) Pub. No.: US 2007/0271527 A1
(43) Pub. Date: Nov. 22, 2007

(54) SYSTEM AND METHOD FOR HOME SCREEN INTERFACE INTEGRATING APPLICATION AND SYSTEM STATUS

(76) Inventors: Julian Paas, Mississauga (CA); Jon-David K. Lacey, Richmond Hill (CA); Mikhail Fomitchev, Vaughan (CA); Jose Jose Rojas, Toronto (CA); Stuart Garrood, Brampton (CA)

Correspondence Address: GOWLING LAFLEUR HENDERSON LLP, SUITE 1600, 1 FIRST CANADIAN PLACE, 100 KING STREET WEST, TORONTO, ON, M5X 1G5, US

(21) Appl. No.: 11/555,311

(22) Filed: Nov. 1, 2006

Related U.S. Application Data
(60) Provisional application No. 60/747,325, filed on May 16, 2006.

(51) Int. Cl. G06F 17/00

(52) U.S. Cl. 715/810

(57) ABSTRACT

A home screen user interface provides application slots for invoking application interfaces for data communication, voice communication (as available) and calendar functions. Associated with the respective application slots are 1-n event slots for displaying individual events from the associated application. Selected communication events or calendar events (e.g. most recent communication events or upcoming calendar events) may be displayed to provide a user with a snapshot of the current day. The home screen may be displayed in accordance with a theme defining display and information attributes.

### CROSS-REFERENCE

This application claims the benefit of U.S. Provisional Application No. 60/747,325 filed May 16, 2006 pursuant to 35 U.S.C. 119(e).

### FIELD OF THE INVENTION

The present application relates to a home screen user interface for controlling a device and to such a user interface integrating application and system status information (e.g. message, calendar and other event information).

### BACKGROUND OF THE INVENTION

For communication and personal organization needs, individuals often turn to electronic devices such as personal computers and, particularly, handheld electronic devices (e.g. mobile telephones, personal digital assistants (PDAs), etc.). These devices provide data and, optionally, voice communication capabilities as well as calendar and alarm functions to organize appointments and the like and other applications.

Commonly, electronic devices provide a graphical user interface (GUI) comprising a home screen (sometimes a “desktop” on a personal computer) for controlling the operation of the device. From the home screen, a user may invoke user interfaces for applications and/or device functions through user interface components such as sub-screens, menus, etc. Often the user navigates a focus about the home screen to select among the various applications and functions for invocation. Homes screens typically also display brief application and system status information such as battery life, communication network status (e.g. wireless signal strength), time, day and/or date information, and counts of message events (e.g. unread email, SMS, IM, etc).

However, users want home screen interfaces that provide them with more information to facilitate better use of their devices. A counter that indicates to a user that there is unread email is helpful but the user is required to launch an email interface to see whether to open and view the email. Users want to be able to glance at the home screen to quickly check application and system status information to make informed choices whether to navigate further, as applicable, and bring up a specific interface to more information and features.

A solution that addresses one or more of these issues is therefore desired.

### BRIEF DESCRIPTION OF THE DRAWINGS

In order that the subject matter may be readily understood, embodiments are illustrated by way of examples in the accompanying drawings, in which:

FIGS. 1-5 are example screen views of a home screen integrated presentation GUI in accordance with respective embodiments; and

FIG. 6 is a block diagram of a storage device showing software components in accordance with an embodiment;

FIG. 7 is a block diagram showing an example interaction between selected software components of FIG. 6 in accordance with an embodiment;

FIGS. 8-9 are flowcharts of operations, in accordance with an embodiment, for the integrated presentation of information in a home screen; and

FIG. 10 is an example of a handheld device adapted in accordance with an embodiment.

### DETAILED DESCRIPTION

A home screen user interface provides application slots for invoking application interfaces for data communication, voice communication and calendar functions. Associated with the respective application slots are at least one event slot for displaying individual events from the associated application. Selected respective communication and calendar events (e.g. most recent communication events or upcoming calendar events) may be displayed to provide a user with a snapshot of the current day. The home screen may be displayed in accordance with a theme defining display and information attributes. Method, system, computer program product and other aspects will be apparent to those of ordinary skill in the art.

FIGS. 1-5 are example screen views of an integrated presentation GUI displaying calendar and other personal organizational events with message events in accordance with respective embodiments as described further below.

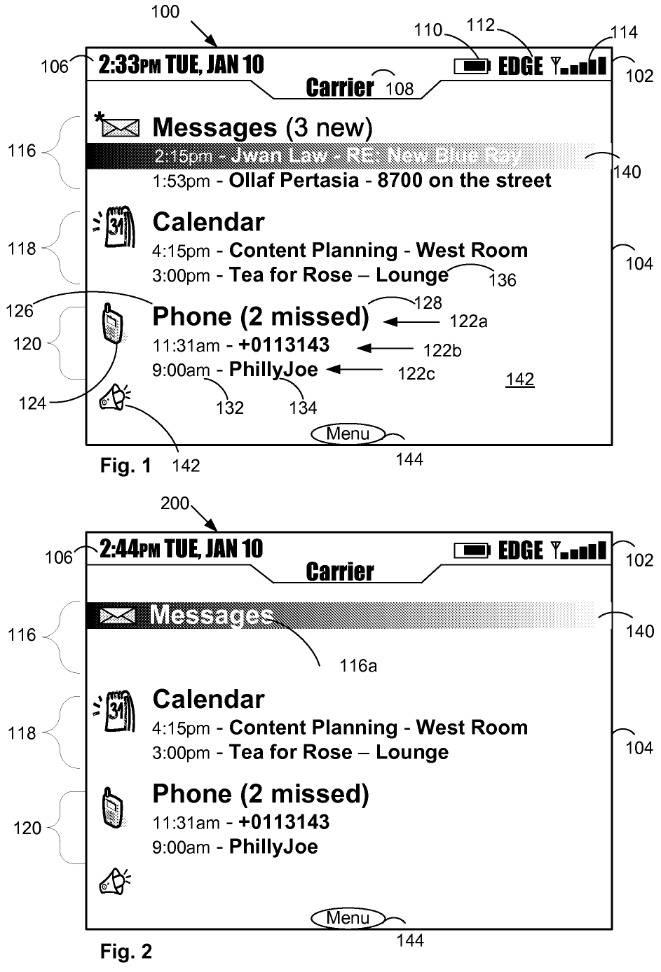

With reference to FIGS. 1-2, there are illustrated views 100 and 200 of a home screen providing a list of selected communication and organizational applications capable or presenting information for respective communication and organizational events according to an embodiment. Typically the communication events represented are those that have occurred most recently while organizational events are those that are occurring or will next occur in the future.

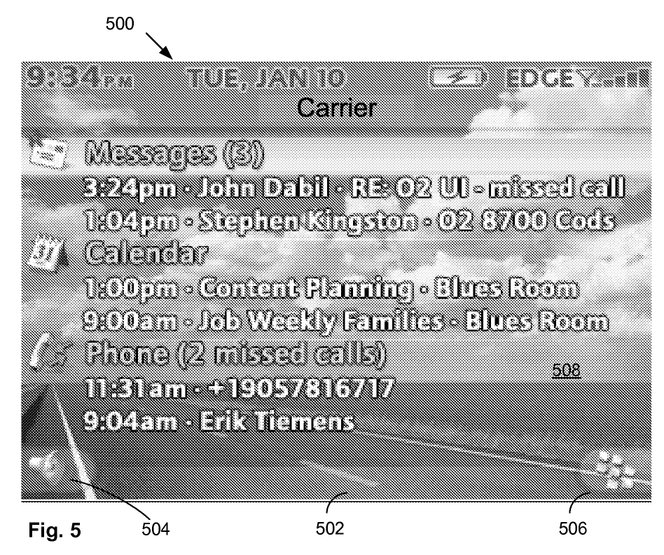

View 100 comprises two major display portions, namely, upper banner status display portion 102 and primary home screen list display portion 104. Upper banner status display portion 102 is configured to present various status information related to the device generally and other applications. The status information of portion 102 comprises day, date and time 106, carrier branding information 108, battery life 110, wireless network name 112 and wireless network signal strength 114. Other status information such as other wireless network information, (roaming status, Bluetooth® communications, etc.) communication event counts (e.g. for email, IM, SMS/MMS, WAP, etc. as applicable), alarm, call forward, call timer, etc. may be indicated as is well known to ordinary persons skilled in the art. Status display portion 102 typically does not permit user navigation or interaction with elements of the portion. A lower banner portion will be described with reference to FIG. 5.

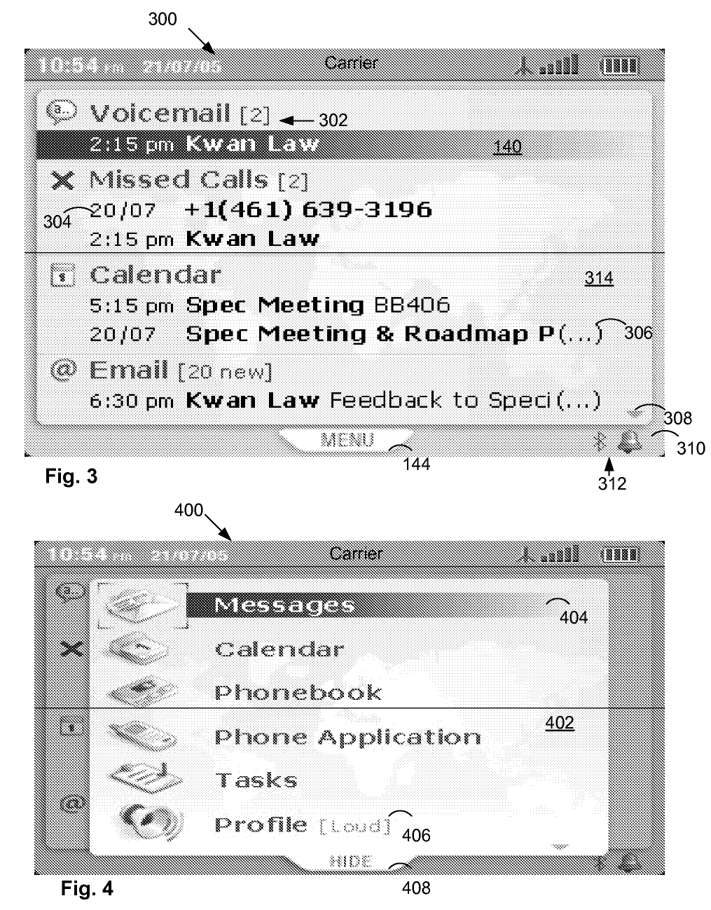

Below portion 102 there is a primary home screen list display portion 104 configured to present a list of selected communication and organizational applications with information for individual events. In the present embodiment there is shown message application and message event portion 116, calendar application and calendar event portion 118 and phone application and event portion 120. As will be apparent, the order of the portions 116-120 may be varied and other, additional or fewer applications may be displayed on the home screen. For example, the embodiment of FIG. 3 illustrates an additional application and event portion for voicemail. Message, phone and calendar applications are displayed in a different order and, as applicable, in association with different names and icons.

The application and event portions 116, 118 and 120 show past voice and/or data events and current or upcoming calendar appointments in a single list having a common display format to permit a user to get a snapshot of the user's activities especially for a current day. Individual events in the list are typically displayed in accordance with a time of occurrence associated with the event. As will be further illustrated and described, as calendar events become current, they are removed from the integrated list once completed. These time organization-related events may be retained within their associated application data store for maintaining a history of such events.

A user may navigate a focus (e.g. 140 of FIG. 1 or FIG. 2) about the home screen list using a pointing or other device (e.g. a thumb wheel, mouse, touch screen device) or keys to highlight a particular list element for action as is well known. Navigation assists e.g. 308 of FIG. 3 indicate that additional list elements are available for display upon navigation by the user. When the focus is brought to an individual event, a specific action for the event (e.g. “open”) or a context sensitive action may be invoked. For example, in FIG. 1, the message event in portion 116 may be opened directly for viewing and further action. In FIG. 2, the focus highlights the message application 116a of portion 116. The message application interface may be invoked. In fact, view 200 illustrates the home screen after invocation and return from the message interface (not shown). Upon return, no “new” email remains so the count of such is no longer displayed and the individual new message events are not shown.

The application and event portions share a similar display format described in greater detail below. For example, with reference to phone application and event portion 120, there is an application slot 122a and 1-n (in this case two being illustrated in the example) event slots 122b and 122c showing respective individual event information. The application slot 122a shows an icon 124, name 126, and count of recent events 128. Event slots include a time of occurrence 132 and respective event information. Phone event information includes caller number 134 or if an address book application is present or caller ID information transmitted, a substituted contact name or caller ID for the caller. Opening a call event may bring up a call log interface or dial the caller as applicable.

Calendar event information includes a meeting subject and optional location information 136. If either information is too long to fit on a line of the display, it may be truncated e.g., terminating with “. . . ”. (See too view 300 of FIG. 3 and event 306). If the event is scheduled on the current day, the time will be shown using the localized (i.e. preference) time format. If the event is scheduled beyond the current day, the date will be shown using a localized MM/DD format. (See event 304 of FIG. 3). This time display format may also apply to communication events.

The phone application supports the representation of new missed call status. It supports different icon and text representations when there are new missed calls. This allows it to show as “Phone” or “Call Log”, but when there are missed calls it could show as “Missed Calls (2)” (e.g. see FIG. 3). It also supports the use of a new indicator that will show when there are new missed calls. Voicemail may be represented as an application. When launched, it will automatically call the device user's voicemail. If no voicemail number is defined, it will use the disabled icon representation if provided by the theme. The application icon will be able to represent when there is new voicemail in the same way messages does. A new voicemail is one that is received since the last time the voicemail application was invoked. A voicemail is no longer new once the voicemail application is invoked. New voicemails that remain unheard are marked as such. Thus voicemail may represent a count of new and/or unheard voicemail.

Toward the bottom of home screen portion 104 there is displayed a profile icon element 142 and menu button element 144. Each element 142 and 144 is positioned at the margin of the display nearest a respective associated key or button of the device (not shown), which is configured to invoke the associated feature. The home screen interface is further configured to permit a user to navigate a focus to these elements and invoke the associated interface as well. Profile icon element 142 is associated with a profile feature to permit a user to configure how the device notifies the user of events via various output devices (e.g. ringer/bell tones, lights, vibrations, etc). Such options are grouped into profiles (e.g. Loud, Silent, Normal) well-known to persons of ordinary skill in the art. Menu button element 144 invokes an application list (i.e. a listing of applications) to enable a user to select and invoke an application or device feature or to organize the application list. An embodiment of the application list menu is further described as view 400 of FIG. 4.

View 300 of FIG. 3 illustrates an alternative embodiment of the device GUI. This home screen GUI includes a voicemail application slot 302. Voicemail service is often provided by voicemail equipment coupled to the device from time to time (e.g. carrier network equipment or voicemail equipment of a VOIP or POTS telephone system) (not shown). The device may include a voicemail feature that interacts with the remote voicemail service to obtain voicemail data including new voicemail counts and, as applicable, time and caller information for display.

One difference between the present embodiment and that shown in FIGS. 1 and 2 is a lower banner status display portion 310 configured to display similar status information (e.g. Bluetooth status and alarm 312) to that of upper banner status display portion 102. As well, there is illustrated a home screen background image 314 over which the elements of the home screen are displayed.

Menu element 144 may be invoked to bring up an application list 402 menu, an embodiment of which is illustrated as view 400 of FIG. 4. Application list 402 is navigable by a user to move a focus 404 about the list and invoke device applications such as those selected for showing on the home screen GUI and others not on the home screen. Focus 404 illustrates a different embodiment from focus 140. The application list 402 menu may overlay a portion of the home screen 104 and display an icon and name for each application slot and optionally application status information. For example, the profile application slot 406 shows the active profile name. Menu button element 144 is replaced with a hide button 408 to close the application list 402 to return to the home screen view 300. The order of display in the list may be configurable by a user such as via an organize application interface (not shown). Some applications may be hidden and not displayed in the list 402.

FIG. 5 illustrates a further embodiment of the device home screen GUI similar to the embodiment of FIG. 1. View 500 shows a lower status display banner 502 with profile icon 504 and menu icon 506. A background image 508 is also shown.

A single device may be provisioned with one or more home screen embodiments. The features of each embodiment may be configured and the configuration grouped to define individual themes. A theme-picking interface may be configured to enable a user to select a current theme. New themes may be defined and provided to the device such as by downloading.

An application may have a minimum, default visual representation that is used for that application. In addition to this representation, some applications will define alternative representations for use in specific situations such as the home screen, or in banners for example. Take Messages for example. At a minimum, the application provides an icon and a name for its default representation. This default representation is used in icon themes using the icon grid layout (i.e. a ribbon of icons arranged on the display) and in the applications list 402. In one theme, where the home screen comprises a minimal list of application slots to display selected applications, in the messages slot, the application name is represented on the home screen along with a count. In the banner it provides a smaller envelope and a count, but no name.

In the home screen theme represented by way of example embodiments in FIGS. 1-5, the messages application slot is associated with a list of 1-n of the most recent new emails. These additional representations are defined above and beyond the minimum, default representation of an icon and a name. Elements of the default representation can be defined by the theme, or as resources within the application itself. The elements of the default representation are as follows:

Name: The themed name overrides the name provided by the application.

Icon (optional): The themed icon overrides the icon provided by the application. If neither icon is available, the default application icon provided by the theme is used.

Icon—in-focus (optional): This icon is used when the icon is in focus. If no icon—in-focus is available, the normal icon is used.

Icon—disabled (optional): This icon is used when the application is visible, but disabled. For example, when there are no browser service books, the default browser is disabled. If no icon—disabled is available, the normal icon is used.

### Application Representation Summary

The table below shows different representations for each application and the configurable theme elements associated with each. In this implementation: unless marked optional, the elements are required in the theme; all text elements will be fully themeable using the established theme attributes for text; and the items listed under the default representation show additional items above and beyond the default representation elements.

| | | |
|---|---|---|
| Application | Representations | Representation Specific Elements/Behaviors |

Messages - (separate representations are preferably provided for each of the
following: unified inbox, SMS, MMS, SMS and MMS and integrated Internet email
service account inboxes)

| | | |
|---|---|---|
| | Default | New indicator (optional). Overlaid on top of |
| | | icon (See Messages of FIGS. 1, 2 and 5) |
| | Banner Indicator | Icon. Only appears when count > 0 if message |
| | | count option is set to unread or new. If message |
| | | count option is none, only appears when new |
| | | messages. |
| | | Count. Shows unread or new messages |
| | | depending on configuration of message count |
| | | option. |
| | | New indicator (optional). Overlaid on top of |
| | | icon. |
| | Home screen | Icon (optional). Used when item is not in focus. |
| | | Icon In-focus (optional). Used when item is in |
| | | focus. |
| | | New indicator (optional). Overlaid on top of |
| | | icon. (See Messages of FIGS. 1, 2 and 5) |
| | | Name (optional). Used when item is in not in- |
| | | focus. When item has a count the name is shown |
| | | as “Messages (12 unread)”. It will either say |
| | | unread or new depending on the message status |
| | | setting. |
| | | Name In-focus (optional). Only appears when |
| | | item is in focus. When item has a count the name |
| | | is shown as “Messages (12 unread)”. It will either |
| | | say unread or new depending on the message |
| | | status setting. |
| | | Count (optional). Will display according to the |
| | | show message count options. Will either show |
| | | New, Unread or not at all. Will display the count |
| | | inside parentheses - e.g. (12 unread). When the |
| | | count is zero, it is not displayed at all. It will either |
| | | say unread or new depending on the message |
| | | status setting. |
| | | Minimum/Maximum new messages (optional). |
| | | Indicates the minimum number of emails to show |
| | | when the layout is space constrained and the |
| | | maximum number to show when the layout is not |
| | | space constrained. |
| | | Message format (optional). Indicates how |
| | | messages will be formatted. Including: |
| | | Whether to show the message icon |
| | | Text style for Time/Date. Whether |
| | | Time/Date is shown will depend on |
| | | message list settings. |
| | | Text style for Sender |
| | | Text style for Subject |
| Phone | Default | New indicator (optional). Overlaid on top of |
| (Includes Call Log) | | icon |
| | Banner Indicator | Icon. Only appears when count > 0. |
| | (Missed Calls) | Count. Shows number of missed calls, if |
| | | information is available. |
| | Home screen | Icon (optional). Used when item is not in focus |
| | | and there are no missed calls. |
| | | Icon In-focus (optional). Used when item is in |
| | | focus and there are no missed calls. |
| | | Icon with New (optional). Used when item is not |
| | | in focus and there are missed calls. |
| | | Icon In-focus (optional). Used when item is in |
| | | focus and there are missed calls. |
| | | New indicator (optional). Overlaid on top of |
| | | icon. |
| | | Name (optional). Used when item is not in-focus |
| | | and there are no new missed calls. E.g. - “Call |
| | | Log” |
| | | Name In-focus (optional). Used when item is in- |
| | | focus and there are no new missed calls. |
| | | Name with New (optional). Used when item is |
| | | not in-focus and there are missed calls. E.g. “(2 |
| | | new) |
| | | Name In-focus with New (optional). Used |
| | | when item is in-focus and there are missed calls. |
| | | E.g. “Missed Calls (2 new)” |
| | | Count (optional). Shows the number of new |
| | | missed calls. Will display the count inside |
| | | parentheses - e.g. (12). When the count is zero, |
| | | it is not displayed at all. |
| | | Minimum/Maximum new missed calls |
| | | (optional). Indicates the minimum number of |
| | | missed calls to show when the layout is space |
| | | constrained and the maximum number to show |
| | | when the layout is not space constrained. |
| | | Missed call format (optional). Indicates how |
| | | missed calls will be formatted. Including: |
| | | Text style for Time/Date |
| | | Text style for Caller |
| Voicemail | Default | New indicator (optional). Overlaid on top of |
| | | icon |
| | Banner Indicator | Icon. Only appears when count > 0. |
| | | Count. Shows number of missed calls, if |
| | | information is available. |
| | Home screen | Icon (optional). Used when item is not in focus. |
| | | Icon In-focus (optional). Used when item is in |
| | | focus. |
| | | New indicator (optional). Overlaid on top of |
| | | icon. |
| | | Name (optional). Used when item is in not in- |
| | | focus. |
| | | Name In-focus (optional). Used when item is in- |
| | | focus. When item has a count the name is shown |
| | | as “Voicemail (12)”. |
| | | Count (optional). Shows the number of unheard |
| | | voicemail. Will display the count inside |
| | | parentheses - e.g. (12). When the count is zero, |
| | | it is not displayed at all. |
| Calendar | Banner Indicator | Only appears in lock mode to show the number of |
| | | pending calendar notifications |
| | | Icon. Only appears when count > 0. |
| | | Count. Shows number of calendar notifications. |
| | Home screen | Icon (optional). Used when item is not in focus. |
| | | Icon In-focus (optional). Used when item is in |
| | | focus. |
| | | Name (optional). Used when item is not in-focus. |
| | | Name In-focus (optional). Used when item is in- |
| | | focus. |
| | | Minimum/Maximum events (optional). |
| | | Indicates the minimum number of calendar events |
| | | to show when the layout is space constrained and |
| | | the maximum number to show when the layout is |
| | | not space constrained. |
| | | Event format (optional). Indicates how calendar |
| | | events will be formatted. Including: |
| | | Text style for Time/Date. |
| | | Text style for Subject |
| | | Text style for Location |

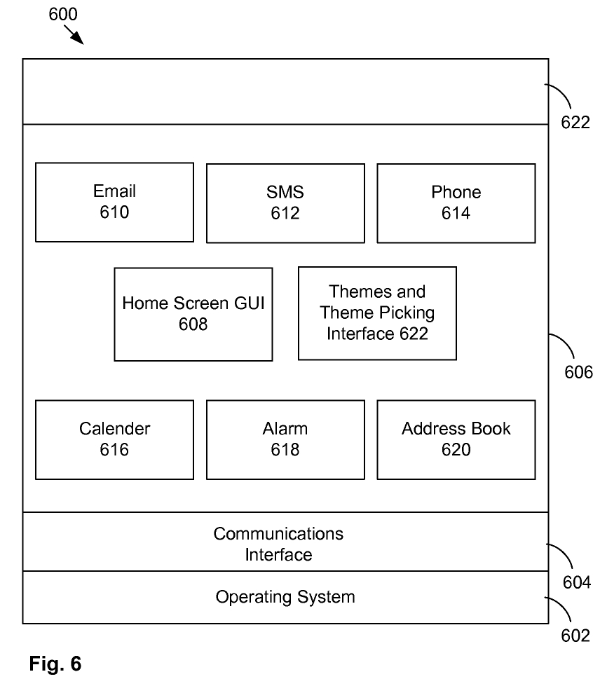

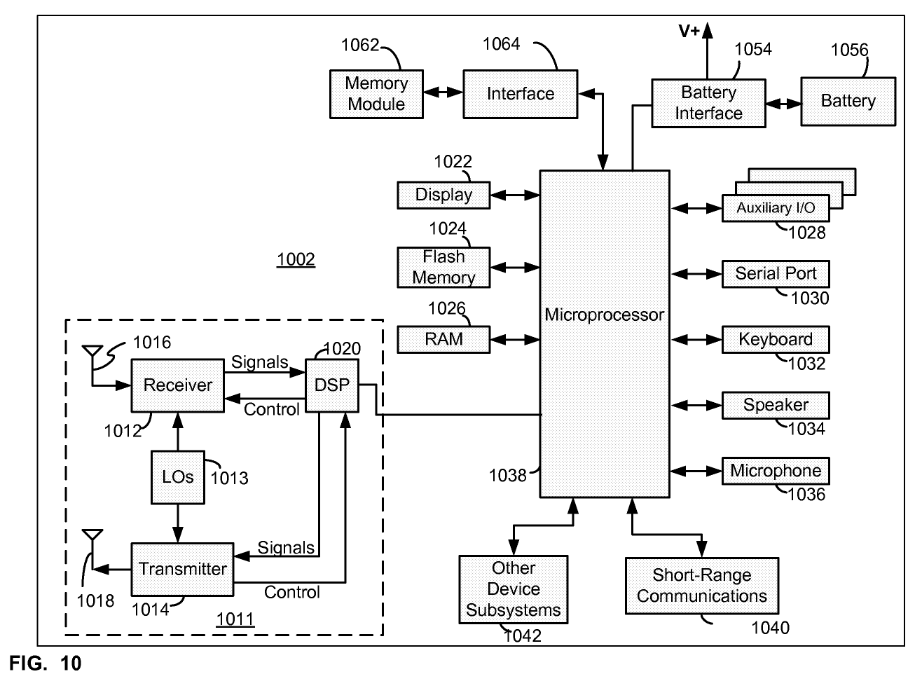

FIG. 6 is a block diagram of a computer programmable medium such as a memory component 600 of an electronic device (e.g. device 1002 of FIG. 10) illustrating example software components in accordance with an embodiment. Memory 600 stores instructions and data comprising an operating system 602, communications interface 604, applications 606 and other components 622. Applications may comprise various data and/or voice communications applications such as email application 610, SMS application 612 and phone application 614. Time-oriented organizational applications include calendar application 616 and alarm application 618. Other information organizational applications include address book 620. Persons of ordinary skill in the art will appreciate that the various applications 606, OS 602 and other components 622 may cooperate with one another and that bright line distinctions between applications may be artificial for purposes of illustration. Coordination may be achieved through a management application providing an integrated GUI such as a personal information manager (PIM) message list interface. Interface 608 operates to present the various views 100, 200, 300, 400 and 500 as described. Themes and theme picking interface 622 enables the display of the various user interfaces for the individual applications (e.g. 610, 612, 614, 616, 618, 620) and the home screen GUI 608 in accordance with defined themes.

Other components 622 (not individually illustrated) may comprise a calculator, a web browser, media applications (e.g. camera, picture viewer, etc.), games, data synchronization, various user-profile functions and options, etc. Interface 608 may also be configured to work with these other components 622. Though not shown, various applications are coupled to persistent stores for persisting data such as messages, calendar items, pictures, etc. as applicable.

Preferably, home screen GUI 608 comprises an application skinning implementation utilizing scalable vector graphics (SVG). SVG is a language for describing two-dimensional graphics and graphical applications in XML, the extensible markup language. It has two parts: an XML-based file format and a programming API for graphical applications. Key features include shapes, text and embedded raster graphics, with many different painting styles. It supports scripting through languages such as ECMAScript and has comprehensive support for animation. A rich set of event handlers such as onmouseover and onclick can be assigned to any SVG graphical object. Additional information is available at http://www.w3.org/Graphics/SVG/. A goal of skinning is to separate the presentation (GUI) of the application from the business logic (functionality) and allow the GUI to be defined through an external file (SVG XML) that can be created and “late bound” to application code. In particular, the themes (622) may be defined in accordance with SVG.

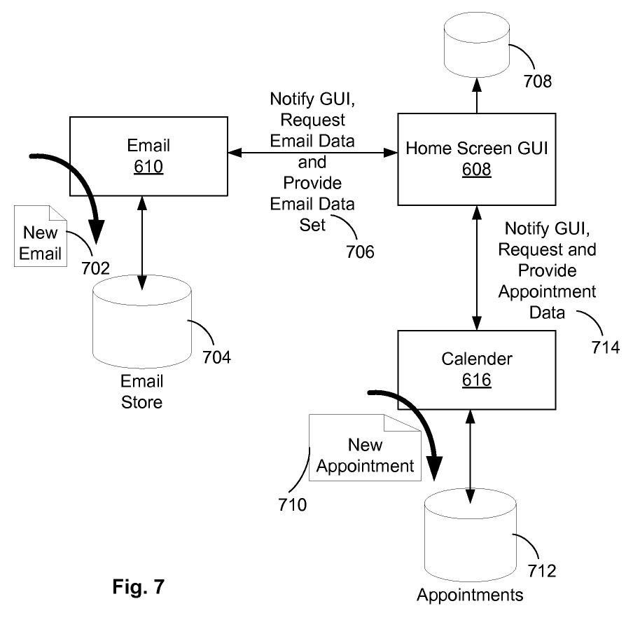

FIG. 7 is a block diagram showing an example interaction between selected software components of FIG. 6 in accordance with an embodiment. In the illustrated embodiment, message applications such as email application 610 persist email data and provide a set of new email data 706 to home screen GUI 608. Email application 610 may prompt GUI 608 to pull the data set 706 when new email 702 arrives. The email data set 706 may include information summarizing the new mail events for display as an event in the slots for the messages portion 116 of the home screen 104. GUI 608 may review the set 706 and determine which of the events (i.e. new email) to display and how to display it in accordance with the configuration of the theme. Typically 1-n of the most current new emails are shown in portion 116. Home screen GUI 608 may determine which email among the new email are the most current and the number of it to show (e.g. view 100 shows only 2 messages).

Similarly organizational event applications such as calendar application 616 persist appointment events 710 and provide calendar event data 714 including information summarizing the event for display in portion 118 by home screen GUI 608. A protocol may be defined to exchange data and data operations between the primary event applications (e.g. 610 and 616) and GUI 608 so that, among other operations, new events may be added and expired events deleted from the home screen display. Alternatively, the applications (610, 616 and/or 608) may provide APIs to obtain/receive the required data to define the event of the respective event list. A person of ordinary skill in the art will recognize how to program such an interface.

By way of example, with reference to FIG. 7, a new email 702 is received via email application 610 and persisted to email store 704. Email application 610 provides sufficient data 706 to GUI 608, including summary information to add a message event to the list for display in portion 116. GUI 608 may persist this data to its store 708 and/or maintain same in memory 602. Should a user wish to work with the associated email (e.g. open, reply, delete, forward etc.) from GUI 608, GUI 608 is configured to invoke the email application 610 to facilitate such interaction (not shown). GUI 608 and email application 702 may distinguish between new messages and unread messages. A message may be considered new if it is received since the last time the email application's interface was invoke to present a list of messages for review by the user. New email may be deemed not new upon such an event (invoking the email application's interface) on the assumption that the user looks at the summary information for the new emails. Unread emails are those that remain unopened or were opened but marked as unopened. Thus distinguishing new and unread enables further refinements in currency. GUI 608 may be configured to show a count of new or unread email.

As well, FIG. 7 also shows a new appointment 710 received via calendar application 616 and persisted to store 712. New appointment 710 may be defined via a user interface of application 616 or received via a data message (e.g. like an email) invitation or as a result of synchronization between application 616 and a remote associated calendar application (not shown). For example, associated calendar applications may reside respectively on an enterprise computer and a portable device (PDA). Calendar application 616 provides sufficient data 714 to GUI 608, including summary information, to add the appointment event to the list for display in portion 118. Again this data 714 may be persisted as necessary to store 708 or stored in memory 602. GUI 608 may be configured to invoke a calendar interface to open a specific appointment to facilitate working with the appointment (not shown). Similar activities (i.e. data exchanges between application 712 and home screen GUI 608) may occur for updated or deleted appointments. Appointments are also removed from display on the home screen once completed. A data exchange may be triggered in response to event completion.

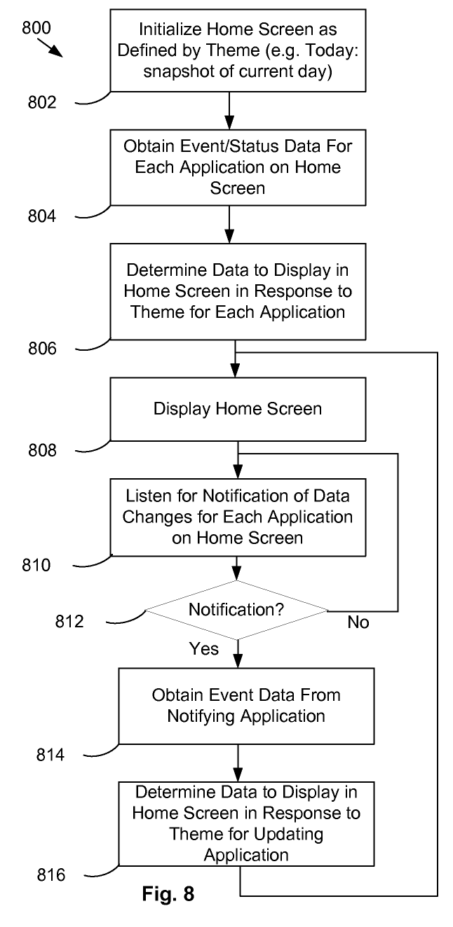

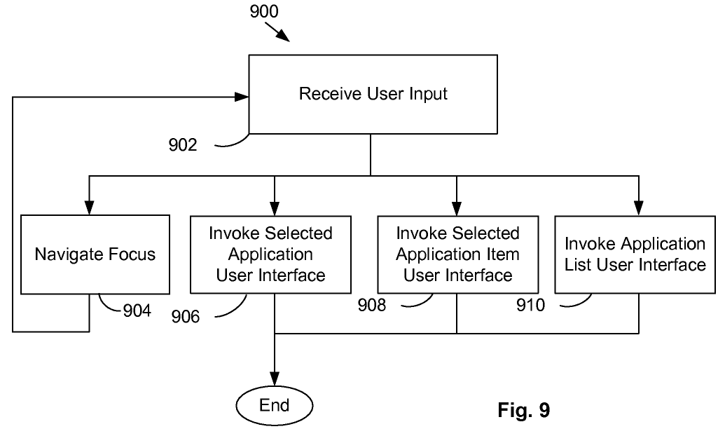

FIGS. 8 and 9 are flowcharts of operations 800 and 900, in accordance with an embodiment, for home screen GUI providing application slots with individual event information in a list. At step 802, the home screen is initialized as defined by the theme requirements. At step 804, event and device status data is obtained for each application in the home screen. The specific data and format is determined in accordance with the theme (e.g. which email events, truncating long data strings, new vs. unread counts, date format, icons etc.). The home screen is displayed at step 808. Home screen GUI 608 may listen for notification, or otherwise be notified, of data changes from the various applications (steps 810-812). If a change is notified, event data is obtained from the notifying application, 814 and the data to display determined according to the theme (step 816). Operations may loop to step 808 to re-display the home screen with the new data.

In conjunction with data updates from the applications, the home screen is responsive to user input and simplified user input operations 900 are shown in FIG. 9. In response to user input received (step 902), various operations may be occasioned. The focus may be moved about the home screen and updated appropriately (step 904). An application slot may be in focus and the selected application's user interface invoked (step 906) or an event item from an application may be in focus and the associated interface invoked (step 908) for the item (e.g. open specific message or appointment). The menu button may be in focus and the application list interface invoked (step 910).

FIG. 10 is a detailed block diagram of a preferred handheld device 1002 adapted in accordance with an embodiment that may be used as an electronic device having message and organization system functions and a home screen GUI as described. Handheld device 1002 is preferably a two-way communication device having at least voice and advanced data communication capabilities, including the capability to communicate with other computer systems. Depending on the functionality provided by handheld device 1002, it may be referred to as a data messaging device, a two-way pager, a cellular telephone with data messaging capabilities, a wireless Internet appliance, or a data communication device (with or without telephony capabilities). Handheld device 1002 may communicate with any one of a plurality of base station transceiver systems (not shown) within its geographic coverage area.

Handheld device 1002 will normally incorporate a communication subsystem 1011, which includes a receiver 1012, a transmitter 1014, and associated components, such as one or more (preferably embedded or internal) antenna elements 1016 and 1018, local oscillators (LOs) 1013, and a processing module such as a digital signal processor (DSP) 1020. As will be apparent to those skilled in field of communications, particular design of communication subsystem 1011 depends on the communication network in which handheld device 1002 is intended to operate.

Handheld device 1002 may send and receive communication signals over the network after required network registration or activation procedures have been completed. Signals received by antenna 1016 through the network are input to receiver 1012, which may perform such common receiver functions as signal amplification, frequency down conversion, filtering, channel selection, and analog-to-digital (A/D) conversion. A/D conversion of a received signal allows more complex communication functions such as demodulation and decoding to be performed in DSP 1020. In a similar manner, signals to be transmitted are processed, including modulation and encoding, for example, by DSP 1020. These DSP-processed signals are input to transmitter 1014 for digital-to-analog (D/A) conversion, frequency up conversion, filtering, amplification and transmission over communication network via antenna 1018. DSP 1020 not only processes communication signals, but also provides for receiver and transmitter control. For example, the gains applied to communication signals in receiver 1012 and transmitter 1014 may be adaptively controlled through automatic gain control algorithms implemented in DSP 1020.

Network access is associated with a subscriber or user of handheld device 1002, and therefore handheld device 1002 comprises a memory module 1062, memory module card or a Removable User Identity Module (R-UIM), to be inserted in or connected to an interface 1064 in order to operate in the network. Alternatively, memory module 1062 may be a non-volatile memory that is programmed with configuration data by a service provider so that mobile station 1002 may operate in the network. Since handheld device 1002 is a mobile battery-powered device, it also includes a battery interface 1054 for receiving one or more rechargeable batteries 1056. Such a battery 1056 provides electrical power to most if not all electrical circuitry in handheld device 1002, and battery interface 1054 provides for a mechanical and electrical connection for it. The battery interface 1054 is coupled to a regulator (not shown in FIG. 5) that provides power V+ to all of the circuitry.

Handheld device 1002 includes a microprocessor 1038 that controls overall operation of mobile station 1002. Communication functions, including at least data and voice communications, are performed through communication subsystem 1011. Microprocessor 1038 also interacts with additional device subsystems such as a display 1022, a flash memory 1024, a random access memory (RAM) 1026, auxiliary input/output (I/O) subsystems 1028, a serial port 1030, a keyboard 1032, a speaker 1034, a microphone 1036, a short-range communications subsystem 1040, and any other device subsystems generally designated at 1042. Some of the subsystems shown in FIG. 5 perform communication-related functions, whereas other subsystems may provide “resident” or on-device functions. Notably, some subsystems, such as keyboard 1032 and display 1022, for example, may be used for both communication-related functions, such as entering a text message for transmission over a communication network, and device-resident functions such as a calculator or task list. Operating system software used by microprocessor 1038 is preferably stored in a persistent store such as flash memory 1024, which may alternatively be a read-only memory (ROM) or similar storage element (not shown). Those skilled in the art will appreciate that the operating system, specific device applications, or parts thereof, may be temporarily loaded into a volatile store such as RAM 1026.

Microprocessor 1038, in addition to its operating system functions, preferably enables execution of software applications on handheld device 1002. A predetermined set of applications that control basic device operations, including at least data and voice communication applications, will normally be installed on handheld device 1002 during its manufacture. A preferred application that may be loaded onto handheld device 1002 may be a personal information manager (PIM) application having the ability to organize and manage data items relating to a user such as, but not limited to, e-mail, calendar events, voice mails, appointments, and task items. Naturally, one or more memory stores are available on handheld device 1002 and memory module 1062 to facilitate storage of PIM data items and other information.

The PIM application preferably has the ability to send and receive data items via the wireless network. In a preferred embodiment, PIM data items are seamlessly integrated, synchronized, and updated via the wireless network, with the mobile station user's corresponding data items stored and/or associated with a host computer system thereby creating a mirrored host computer on handheld device 1002 with respect to such items. This is especially advantageous where the host computer system is the mobile station user's office or enterprise computer system. Additional applications may also be loaded onto handheld device 1002 through network, an auxiliary I/O subsystem 1028, serial port 1030, short-range communications subsystem 1040, or any other suitable subsystem 1042, and installed by a user in RAM 1026 or preferably a non-volatile store (not shown) for execution by microprocessor 1038. Such flexibility in application installation increases the functionality of handheld device 1002 and may provide enhanced on-device functions, communication-related functions, or both. For example, secure communication applications may enable electronic commerce functions and other such financial transactions to be performed using handheld device 1002.

In a data communication mode, a received signal such as a text message, an e-mail message, or web page download will be processed by communication subsystem 1011 and input to microprocessor 1038. Microprocessor 1038 will preferably further process the signal for output to display 1022 or alternatively to auxiliary I/O device 1028. A user of handheld device 1002 may also compose data items, such as e-mail messages, for example, using keyboard 1032 in conjunction with display 1022 and possibly auxiliary I/O device 1028. Keyboard 1032 is preferably a complete alphanumeric keyboard and/or telephone-type keypad. These composed items may be transmitted over a communication network through communication subsystem 1011.

For voice communications, the overall operation of handheld device 1002 is substantially similar, except that the received signals would be output to speaker 1034 and signals for transmission would be generated by microphone 1036. Alternative voice or audio I/O subsystems, such as a voice message recording subsystem, may also be implemented. Although voice or audio signal output is preferably accomplished primarily through speaker 1034, display 1022 may also be used to provide an indication of the identity of a calling party, duration of a voice call, or other voice call related information, as some examples.

Serial port 1030 in FIG. 10 is normally implemented in a personal digital assistant (PDA)-type communication device for which synchronization with a user's desktop computer as a desirable, albeit optional, component. Serial port 1030 enables a user to set preferences through an external device or software application and extends the capabilities of handheld device 1002 by providing for information or software downloads to handheld device 1002 other than through a wireless communication network. The alternate download path may, for example, be used to load an encryption key onto handheld device 1002 through a direct and thus reliable and trusted connection to thereby provide secure device communication.

Short-range communications subsystem 1040 is an additional optional component that provides for communication between handheld device 1002 and different systems or devices, which need not necessarily be similar devices. For example, subsystem 1040 may include an infrared device and associated circuits and components, or a Bluetooth™ communication module to provide for communication with similarly enabled systems and devices. Bluetooth™ is a registered trademark of Bluetooth SIG, Inc.

Handheld device 1002 may be configured such as via software (instructions and data) to provide the home screen integrated presentation of information in a GUI as described above.

Although embodiments of the invention have been described herein, it will be understood by those skilled in the art that variations may be made thereto without departing from the spirit of the invention or the scope of the appended claims.

What is claimed is:

1. A method of providing a user interface to control a communication device, said method comprising:
displaying a home screen user interface comprising a plurality of application slots for invoking respective application user interfaces for data communication, voice communication and calendar applications provided by the device;
displaying in association with the respective application slots event information for at least one individual event maintained by the respective application; and
in response to a user selecting an application slot or an associated individual event and requesting an action, invoking respectively the application interface or the application interface for the individual event.

2. The method of claim 1 wherein the respective individual events are selected for displaying in the home screen user interface to provide a user with a snapshot of a current day.

3. The method of claim 1 comprising performing said displaying steps in accordance with a theme defined for the home screen interface.

4. The method of claim 3 comprising determining particular event information to display for each event in accordance with the theme.

5. The method of claim 1 comprising updating the event information in response to changes and displaying in association with the respective application slots the updated event information.

6. The method of claim 5 comprising listening for notification of said changes.

7. The method of claim 1 comprising providing an application list for selecting individual applications for invocation, said application list being invocable from the home screen user interface.

8. The method of claim 7 comprising displaying a button element configured for invoking the application list in the home screen user interface.

9. The method of claim 8 comprising positioning said button element with an associated key/button of the communications device configured for invoking the application list within the home screen user interface.

10. A communication device comprising:
a communication interface for communicating data and voice communications; and
a graphical user interface (GUI) to control the communication device, said GUI configuring the device to:
display a home screen user interface comprising a plurality of application slots for invoking respective application user interfaces for data communication, voice communication and calendar applications provided by the device;
display in association with the respective application slots event information for at least one individual event maintained by the respective application; and
in response to a user selecting an application slot or an associated individual event and requesting an action, invoke respectively the application interface or the application interface for the individual event.

11. The device of claim 10 wherein the respective individual events are selected for displaying in the home screen user interface to provide a user with a snapshot of a current day.

12. The device of claim 10 wherein the device comprises at least one theme for the home screen user interface and the device is configured for performing said displaying steps in accordance with a theme defined for the home screen interface.

13. The device of claim 12 wherein the device is configured for determining particular event information to display for each event in accordance with the theme.

14. The device of claim 10 wherein the device is configured for updating the event information in response to changes and displaying in association with the respective application slots the updated event information.

15. The device of claim 14 wherein the device is configured for listening for notification of said changes.

16. The device of claim 10 wherein the device is configured for providing an application list for selecting individual applications for invocation, said application list being invocable from the home screen user interface.

17. The device of claim 16 wherein the device is configured for displaying a button element configured for invoking the application list in the home screen user interface.

18. The device of claim 17 wherein the device is configured for positioning said button element with an associated key/button of the communications device configured for invoking the application list within the home screen user interface.

19. A computer program product having computer readable code embodied therein, for execution by a processor of an communication device to provide a home screen user interface comprising:
application slots for invoking respective application interfaces for data communication, voice communication and calendar functions;
at least one event slot associated with each respective application slot for displaying individual events from the associated application;
wherein the respective individual events are selected for displaying in the home screen user interface to provide a user with a snapshot of a current day.

20. The computer program product of claim 20 wherein the home screen user interface is configured for display in accordance with a theme.
